(19) United States
(12) Patent Application Publication
(10) Pub. No.: US 2015/0262155 A1
(43) Pub. Date: Sep. 17, 2015

(54) SYSTEM AND METHOD FOR FACILITATING SALE OF PRODUCTS AND SERVICES TO A MOBILE DEVICE USER

(71) Applicant: CHIKKA PTE LTD, Singapore (SG)

(72) Inventor: Dennis Mendiola, New York, NY (US)

(21) Appl. No.: 14/657,892

(22) Filed: Mar. 13, 2015

Related U.S. Application Data
(60) Provisional application No. 61/952,706, filed on Mar. 13, 2014.

(51) Int. Cl. G06Q 20/14; H04L 12/14

(52) U.S. Cl. CPC G06Q 20/145; H04L 12/1467

(57) ABSTRACT

There is provided a system and method for facilitating sale of products and services to a mobile device subscriber comprising the monitoring of the user's access to a web resource and recommending a suitable data service plan based on the user's access to the web resource. An added feature is the provision of a free-trial period to the subscriber if the web resource accessed is a first time access or an access after an idle period of time. The method is particularly advantageous in helping to recommend action/app specific plans to prepaid users in a bid to lower the price point chargeable to these prepaid subscribers without diminishing their Internet experience.

### FIELD OF THE INVENTION

The present invention relates to a system and method for facilitating sale of products and services to a mobile device user. In particular, the invention is suited to facilitate sale of prepaid plans and related services to a mobile device user.

### BACKGROUND ART

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Prepaid subscribers to Internet services are typically cost sensitive and are generally unable to afford the luxury of an ‘always on’ Internet or data connection which are readily available to postpaid subscribers. Such ‘always on’ Internet connections are typically charged at a per month package of about $30, working out to be about $1 per day. Other popular variations are $1 per day with a cap of 1 GB, or $0.25 a day with a cap of 20 MB.

To mitigate the relatively high cost of Internet/data access and to enlarge their market share of the prepaid market, service or network providers such as telecommunications carrier (‘telcos’) have offered a variety of prepaid plans and associated billing structure. The various combinations of plan and billing structure are targeted to bring down the cost of providing Internet service to prepaid users. These plans include a different charging/billing scheme compared to the more typical $1 per day. While the above provides a variety of plans suited for different needs of a prepaid subscriber, there continually exists a need to assist a prepaid subscriber, faced with a huge variety of options, to make an informed decision on the types of products and services to purchase. There further exists a need to customize or tailor-made a prepaid plan with specific web products or services to a prepaid user.

The invention seeks to meet the needs at least in part.

### SUMMARY OF THE INVENTION

The inventors note a particular difference in behaviour between a user on his mobile device (such as smartphone) and that on his personal computer (PC). Typically, a person using a mobile device such as a smartphone would activate a particular software application (colloquially referred to as an ‘app’) or act on a specific notification to connect to the Internet; while a person using a PC or laptop would typically launch an Internet browser first, as the messengers and/or email apps automatically open in the background.

Using the above insight, the inventors have developed the present invention. An aspect of a dedicated software application particularly suited (but not limited to) for installation on a smartphone to monitor a user's access to web resources in order to customize or recommend data service plan for the user. The smartphone may be preinstalled with the software application at the time of purchase of the smartphone or may be downloaded for free thereafter.

In accordance with an aspect of the present invention, there is provided a method for facilitating sale of products and services to a mobile device subscriber comprising the steps of monitoring of the user's access to a web resource and recommending a suitable data service plan based on the user's access to the web resource. An added feature is the provision of a free-trial period to the subscriber if the web resource accessed is a first time access or an access after an idle period of time. The method is particularly advantageous in helping to recommend action/app specific plans to prepaid users in a bid to lower the price point chargeable to these prepaid subscribers without diminishing their Internet experience.

In accordance with another aspect of the present invention there is provided a system for provisioning data service plan to a user comprising a web resource traffic monitor arranged to monitor a user device access to at least one web resource and generate user access data; and a data service planner arranged to receive the access data and recommend to the user a data service plans for subsequent assess to the at least one web resource; wherein the data service plans include a pay-per-specific time data service plan or a pay per action data service plan.

Preferably, the web resource traffic monitor is integrated with the user device.

Preferably, the web resource traffic monitor is configured to run as a background application on the user device for the monitoring of access to the at least one web resource.

Preferably, the web resource traffic monitor is configured to determine if the web resource is accessed by the user device for the first time.

Preferably, if the web resource is accessed for the first time, the web resource is subsequently accessible without cost to the user for a pre-determined time.

Preferably, if the web resource is accessed for the first time, the web resource is accessible without cost to the user for a subsequent predetermined number of access to the web resource.

Preferably, if the web resource is not accessed by the user for the first time, the web resource traffic monitor is configured to determine a time difference between the previous access of the at least one web resource and the most recent access of the at least one web resource.

Preferably, if the time difference is greater than a predetermined period, then subsequent access to the web resource is available without cost to the user for a pre-determined time.

Preferably, the data service planner is in data communication with a subscriber database to check if the user is an existing subscriber of a data service plan.

Preferably, the system further comprises a whitelist in data communication with the web resource traffic monitor, the whitelist maintaining a list of web resources available for toll free access by the user device.

Preferably, each subsequent action to access the web resource includes the actions retrieve, input or manipulate data.

Preferably, each action to retrieve, input or manipulate data is charged or billed based on a flat fee for a defined set of subsequent actions.

In accordance with another aspect of the present invention there is provided a method for provisioning data service plan to a user comprising the steps of: monitoring the user's access to a web resource; and recommending a data service plans for subsequent access to the web resource based on the user's access to the web resource; wherein the data service plan include a pay-per-specific time data service plan or a pay per action data service plan.

Preferably, the step of monitoring the user's access to the web resource is performed on a user device.

Preferably, the step of monitoring includes determining if the web resource is accessed by the user device for the first time.

Preferably, if the web resource is accessed for the first time, the web resource is accessible without cost to the user for a pre-determined time.

Preferably, if the web resource is accessed for the first time, the web resource is accessible without cost to the user for a subsequent predetermined number of access to the web resource.

Preferably, if the web resource is not accessed by the user for the first time, the method includes a step of determining a time elapsed between the previous access of the at least one web resource and the most recent access of the at least one web resource.

Preferably, if the time elapsed is greater than a predetermined period, then the web resource is accessible without cost by the user for a pre-determined time.

Preferably, the step of recommending includes a step of checking if the user is an existing subscriber of a data service plan.

### BRIEF DESCRIPTION OF THE DRAWINGS

The present invention will now be described, by way of example only, with reference to the accompanying drawings, in which:

FIG. 1 is a flowchart of a method for facilitating sale of products and services to a user subscriber according to at least one embodiment of the invention.

FIG. 2 is a flowchart of a method for facilitating sale of products and services to a user subscriber according to another embodiment of the invention where a free trial of the product or service is provided.

FIG. 3 is a block diagram of a system for facilitating sale of products and services to a user subscriber according to another embodiment of the invention.

Other arrangements of the invention are possible and, consequently, the accompanying drawings are not to be understood as superseding the generality of the description of the invention.

### DESCRIPTION OF EMBODIMENTS OF THE INVENTION

It is to be appreciated that “free access” or “free trial” in the context of access to web resources including URLs, APIs or other websites/IP addresses refer to toll free ‘always on’ data access, i.e. access to these URLs, APIs, websites/IP addresses would be free to the user as provided by a telecommunications carrier or network provider. Such ‘always on’ data access is to be distinguished from any subsequent actions to retrieve, input or manipulate data, including downloading of videos/audio files for example. Actions to retrieve, input or manipulate data may be chargeable, although the access to the data itself may be toll free.

In addition, “free access” in the context of access to web resources such as mobile applications (“apps”) refers to downloading such apps but usage of such “apps” to download/view/stream or perform other functions may be chargeable.

It is further to be appreciated that ‘Internet access’ in the context of the description generally refers to mobile data Internet service such as GPRS, Enhanced Data rates for GSM Evolution (EDGE), 3G, LTE, 4G network, Wi-Fi tethering etc. unless otherwise stated.

Various examples of data service plans offerings and billing structure that are mentioned in the embodiments may be summarized as follows. These data service plans include pay-per-specific time and pay-per-action billing structure as follows.

i. Always-On Internet connection (with certain activities not allowed, such as file sharing or video streaming)=$0.25 to $0.50 per day (instead of the more typical $1 per day);
ii. Always-On Internet connection for selected web resources such as Facebook™ or Instagram™ charged at $0.10 per day;
iii. Always-On Internet connection for selected web resources with certain restrictions such as Facebook™ but capped at 5 MB at $0.05 per day; or Facebook™ with no video at $0.05 per day;
iv. Internet connection for access to certain web resources for a fixed number of times—for example, download of ten (10) Youtube™ videos for $0.20;
v. Internet connection for specific actions coupled with offline usage for example, one hour of video streaming with three days of offline play of the streamed/cached video (at $0.20); or one day of video streaming for one week of offline play of the streamed video (at $0.99).

It is to be appreciated that the above examples are not exhaustive and may be combined or mixed to form other hybrid billing scheme/structures. It is to be further appreciated that a prepaid user may be given an option to switch from one billing structure to another. Such an arrangement may be supported by toggling between a billing infrastructure that implements a pay-per-specific time model and an independent billing module implementing the pay per action model.

In accordance with an embodiment of the invention there is a method for facilitating sale of products and services to a user.

Preferably, the sale of products and services include data service plans targeted to subscribers of a network provider or telecommunication carrier based on the preference and access of web resources by such subscribers, which will be elaborated further below. The embodiment is especially suited for subscribers who are prepaid subscribers. Prepaid subscribers belong to a category of subscribers who are particularly cost-sensitive to costs associated with data service plans and wish to extract maximum benefit and utility from such plans.

Data such as the access of web resources and the frequency of access may be tracked and monitored by a dedicated software application installed on a user device such as a smartphone. The smartphone comprises a non-transitory computer readable medium that stores a computer program to be executed by the smartphone such that when executed, the software (hereinafter referred to as ‘App’) is configured to run in the background of the smartphone of a prepaid subscriber user and continuously monitors the actions of the user to establish his Internet access patterns. The App is also responsible for calculating the amount of time spent on Internet access for billing purposes.

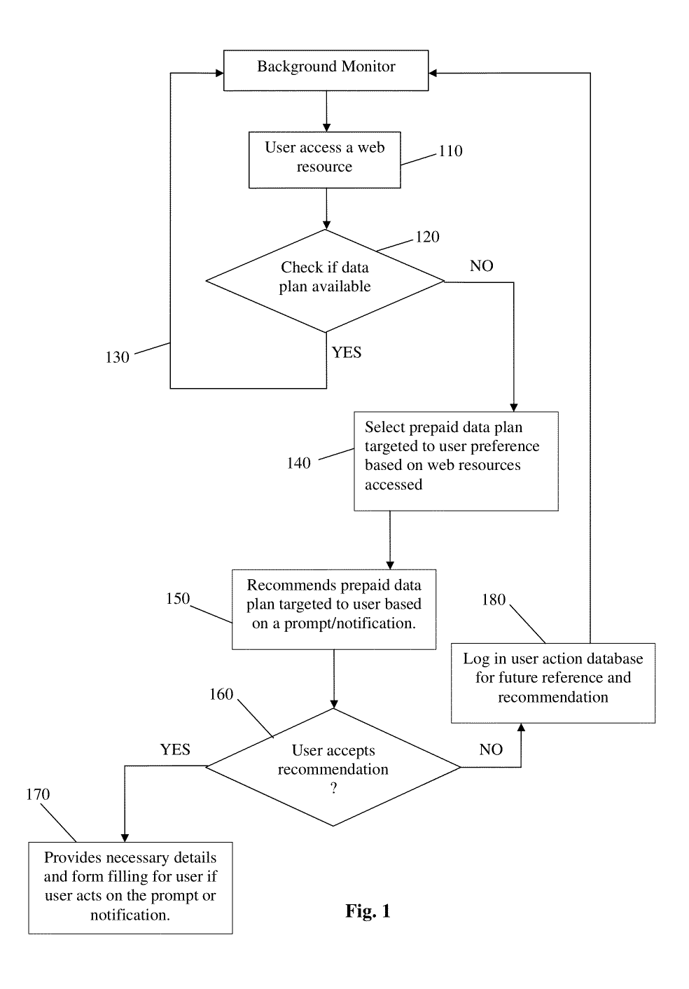

In one particular embodiment, with reference to FIG. 1, a user of the smartphone accesses a web resource, for example an image-sharing platform such as Instagram™ via the launching of an Instagram™ application (step 110). The App is configured to process the following in sequence:—

i. checks with a backend subscriber database if there is an active data service plan in place for the user to access the web resource (step 120);
ii. if there is an active service data plan in place that allows Instagram™ to run properly, the app does nothing (step 130);
iii. if there is no data plan in place, the app prompts or recommends ‘cross-sells/up-sells etc.’ a specific data service plan such as (step 140):—
a. Always-On Internet connection for Instagram™ charged at $0.10 per day (or any other price as determined by the telco and/or service provider);
b. Always-On Internet connection charged at $0.25 to $0.50 per day (or any other price as determined by the telco and/or service provider);

### OR

c. other plans which include the Instagram™ app, along with other similar social networking apps, in a bundled form.

The recommendations are prompted to the subscriber user for his action (step 150). If the subscriber accepts the recommendation based on decision step 160, then the subscriber will be prompted to provide the necessary details and information to complete the transaction (step 170). If the subscriber does not accept the recommendation, the response will be logged for future reference and recommendation (step 180). It is to be appreciated that the acceptance of the subscriber at step 170 may also be logged for future reference and recommendations.

In another embodiment, the user subscriber may be notified in the form of being ‘tagged’ or ‘mentioned’ in a social media platform (such as Facebook™ or Twitter™). The subscriber is assumed to be provided such notifications on a no-charge basis (i.e. without cost) regardless of whether he has an active data service plan or not. The user subscriber is thus notified of his ‘tagged’ or ‘mentioned’ status on the social media platform.

Should the user subscriber wish to follow up, he may click on the notification. Upon clicking the notification, the App is operable to:—

i. interrogate a backend subscriber database if there is an active data plan that allows the use of such app in place for the user;
ii. if there is a data plan in place, the app does nothing;
iii. if there is no data plan in place, the app prompts or ‘cross-sell’ a specific data plan such as:—
a. Always-On Internet connection for selected for Facebook™ or Twitter™ charged at $0.10 per day (or any other price as determined by the telco and/or service provider);
b. Always-On Internet connection (with certain activities not allowed, such as file sharing or video streaming)=$0.25 to $0.50 per day (or any other price as determined by the telco and/or service provider);

### OR

c. other similar plans which include the social media platform and other similar apps in a ‘bundled app’ form.

In another embodiment, the subscriber may utilize his browser to visit a specific website or do a quick search using a search engine. As with the previous examples, the App may be configured to check if the subscriber has an existing data plan that would allow browsing and if not, prompt the user to subscribe to a specific plan and allow him to continue with the search. Alternatively, the App may be configured to allow free access to the search results and recommend a data plan specific to a selected search result from the list of search results. For example, if the subscriber selects a simple URL web link, then the recommended plan may be specific to the content of the web link or something such as a general plan, such as an all day browsing plan for $0.20. If the subscriber selects a Youtube™ video, then the recommended plan may be for example a plan for streaming and subsequent downloading or cache-ing of up to ten (10) Youtube™ videos for $0.20 or any other price as determined by the telco and/or service provider; or an hour of video streaming with two days of offline play of the cached Youtube™ video (at $0.05 per video); or one day of unlimited video streaming with one week cache-ing of the videos for offline play (at $0.99) or at any other price as determined by the telco and/or service provider.

As an added feature, the App may be further configured to provide targeted recommendations to the user subscriber based on one or more of the following input variables:—

i. number of rejections/acceptance made to previous recommendations;
ii. frequency of access of a particular type of web resource;
iii. duration of access of a particular type of web resource;

The above non-exhaustive list of input variables will be analysed to determine if the user is likely to proceed with a low priced app-specific data service plan, a bundled data service plan or other types of data service plans including hybrid types. In particular, the input variables are used as an effective tool for up-selling or marketing/recommending data service plans that are more likely to be accepted by a subscriber, or data service plans that are more relevant to a subscriber's web resource access behaviour.

Using the input variable—‘number of rejections/acceptable made to previous recommendations’ as an example, if a user subscriber repeatedly rejects a recommended data service plan (e.g. Facebook™ access at a fixed cost per day) although the recommendation based on his high frequency of access to a web resource, then it suggests to the App and/or any backend system the App is data communicated to that the recommended data service plan is not what the user subscriber is looking for and certain fine tuning to the recommendation has to be made, for example from an access to Facebook™/per day to access to the web resource with an all day surfing which includes other web resources. These tweaked or fine-tuned data service plans will then be recommended to the user subscriber and rejections/acceptance will be logged for future recommendations.

Using the input variable—‘Frequency and Duration of Access of a particular type of web resource’ as an example, if a user subscriber keeps on rejecting a recommended plan (e.g. Facebook™ all Day Plan), but it was noted that when the subscriber does actually buy some other plan, he mostly access Facebook™ and visits other web resources, such as URL links outside and mostly just news and subjects that can be surfed (as opposed to viewed video streaming), then recommendations of Facebook™ All Day plus Surfing for a particular cost will be made.

In addition to the described embodiments, the App may be configured to include a feature for allowing a subscriber to test and use a supposed paid data service on a free trial basis for a predetermined period of time before committing to making a purchase for the service.

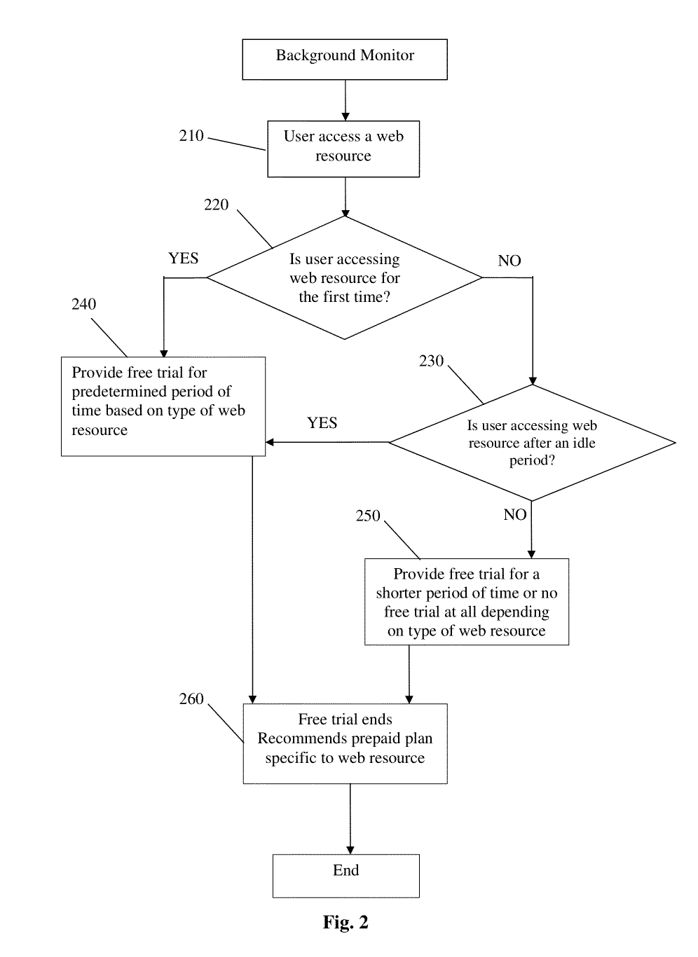

FIG. 2 illustrates a logic flow of the free trial. As an example, the subscriber user launches a particular web service such as a downloaded app from Google™ Playstore™. As described earlier, the App is configured check if he has a data service plan that would allow the proper functioning of that downloaded app (step 210).

If YES, then the user will be allowed to proceed.

If NO, then the App further determines if the user has downloaded or is accessing/using the web resource (the downloaded app) for the first time (step 220).

If the user is not accessing the web resource for the first time, another check is performed to calculate the duration between the last use of the app and the current access to determine if the user “has been idle for quite some time?” or whether is he in fact a regular user and is simply checking to see if there's anything new and interesting with the app (see decision step 230)? Again, as with the above, it would be ideal for a deeper level of integration with the service provider such as Facebook™ for more granular relevant user data, e.g., more accurate data concerning the level of newness or activeness of the user.

Based on the above checks, if this is the first time the user accesses the app or if the user has been idle for quite some time, the user will be recommended or offered a free trial for subsequent access to the web resource for a pre-determined period of time (step 240), enough for the user to make a decision on whether he would like to continue accessing the web resource based on a paid data service plan. The length of time would depend on the kind of app it is. If it is a game app, a relatively shorter period of free trial, say a day or two, may be provided. If it is a social networking app or a messenger app, the free trial may be relatively longer (weeks if not months), so as to provide the user ample time to build up his network in order to ‘see’ the usefulness of the downloaded app.

On the other hand if the subscriber is determined to be a regular user, then he already knows what the web resource is all about. He is probably just checking to see if there's anything interesting “happening today.” In such a scenario, the free trial period would be substantially shorter, say, a couple of minutes to about half an hour (step 250). As described in the preceding paragraph, the length of “shorter free trial time” allowed would depend on the kind of app or web service it is.

The distinction between a first time user and a regular user provides ample time to be provided to a first time user to build his network or otherwise familiarize himself with the app or service. It may take days or weeks to assess whether he likes an app or not. A regular user, however, will most probably take minutes to enhance the level of engagement he has for the app.

As an example to illustrate the period of free trial provided to a user, the service provider/telco may have tied-up with social networking platform Facebook™. In such situation the App will be able to have access to find out if the user is already a member of Facebook™ and if so, whether the user has been active, and/or more specifically, whether the user has been active via mobile devices. The information provided by Facebook™ shall help to determine the most appropriate length and type of trial offer to provide to the user directed to increase the likelihood of future purchase by the user.

Once the free trial ends (step 260), one or more data service plans will be recommended to the subscriber for subsequent access to the specific web resource.

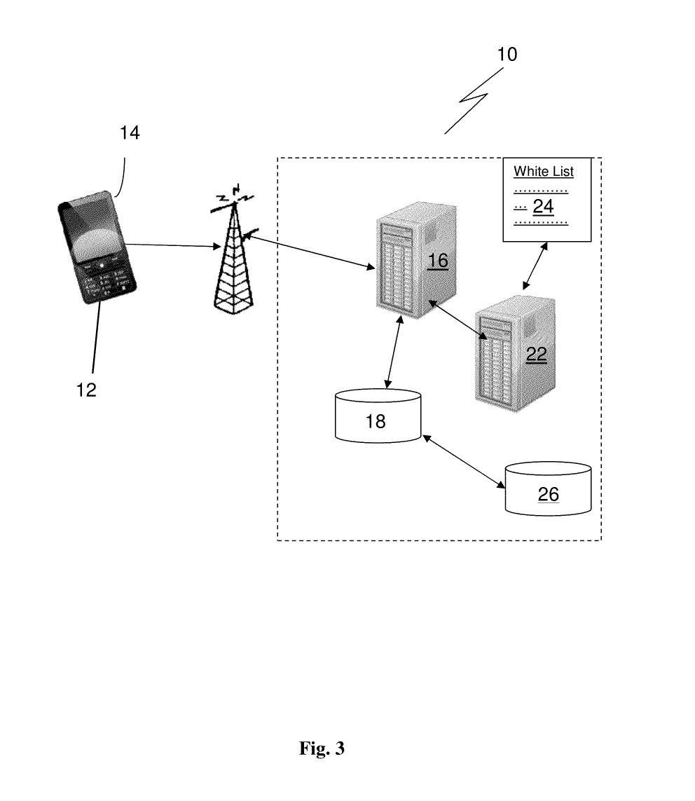

In accordance with another embodiment of the invention as shown in FIG. 3, there is a system 10 for facilitating sale of products and services, such as a data service plan, to a mobile subscriber. The system 10 comprises a web resource traffic monitor 12 arranged to monitor a user device 14 access to at least one web resource and generate user access data; and a recommendation engine or data service planner 16 arranged to receive the access data and recommend to the mobile subscriber a plurality of data service plans for subsequent assess to the at least one web resource.

The mobile subscriber is typically a prepaid subscriber. The plurality of data service plans include a pay-per-specific time data service plan and a pay-per-action data service plan or any other hybrid data service plans as described in the earlier embodiment and will not be further elaborated.

The web resource traffic monitor 12 is arranged to monitor access of the user device 14 to web resources. Web resources include, but are not limited to, URL links, videos, social media notifications, etc. Further, the web resource traffic monitor 12 may be configured to receive location based information or data from the user device 14. For each subscriber, the web resource traffic monitor 12 is configured to generate access data to be received by the data service planner 16.

The data service planner 16 is operable to receive the access data from the web resource monitor 12 and recommend to the subscriber one or more suitable data service plans for subsequent access to the web resource based on the access data of the user device 14 obtained. The obtained access data may comprise a list of web resources accessed by the user device 14 for a particular time period or time frame, and may further include statistical data such as:—

i. number of rejections/acceptance made to previous recommendations of data service plans;
ii. frequency of access of a particular type of web resource;
iii. duration of access of a particular type of web resource;

The above non-exhaustive list of input variables will be analysed to determine if the user is likely to proceed with a low priced app-specific data service plan, a bundled data service plan or other types of data service plans including hybrid types. In particular, the input variables are used as an effective tool for up-selling or marketing/recommending data service plans that are more likely to be accepted by a subscriber, or data service plans that are more relevant to a subscriber's web resource access behaviour.

Using the input variable—‘number of rejections/acceptable made to previous recommendations’ as an example, if a user subscriber repeatedly rejects a recommended data service plan (e.g. Facebook™ access at a fixed cost per day) although the recommendation based on his high frequency of access to a web resource, then it suggests to the App and/or any backend system the App is data communicated to that the recommended data service plan is not what the user subscriber is looking for and certain fine tuning to the recommendation has to be made, for example from an access to Facebook™/per day to access to the web resource with an all day surfing which includes other web resources. These tweaked or fine-tuned data service plans will then be recommended to the user subscriber and rejections/acceptance will be logged for future recommendations.

Using the input variable—‘Frequency and Duration of Access of a particular type of web resource’ as an example, if a user subscriber keeps on rejecting a recommended plan (e.g. Facebook™ all Day Plan), but it was noted that when the subscriber does actually buy some other plan, he mostly access Facebook™ and visits other web resources, such as URL links outside and mostly just news and subjects that can be surfed (as opposed to viewed video streaming), then recommendations of Facebook™ All Day plus Surfing for a particular cost will be made.

Upon receiving the access data from the web resource monitor 12, the data service planner 16 recommends to the subscriber the data service plans based on the earlier described process in FIGS. 1 and 2.

Due to the huge amount of subscriber datasets that may be from multiple sources and in a structured or semi-structured form, the Recommendation Engine 16 employs Deep Data or Big Data Analytics to process and yield the required information (input variables) for making targeted data service plans to subscribers.

The system 10 may be hosted by a mobile network operator or a telecommunications carrier.

The user device 14 may preferably be a mobile phone. More preferably, the computing device 14 is a smartphone capable of the installation of mobile software application or ‘app’. For accessing web resources, the computing device 14 is connectable to the Internet via various mobile data services such as GPRS, Enhanced Data rates for GSM Evolution (EDGE), 3G, Wi-Fi, LTE, 4G network etc.

The system 10 may be hosted by a network operator or telecommunications carrier. The system 10 may further be arranged to be in data communication with an Internet access adjustment facilitator 22 and a whitelist 24 in data communication with the Internet access adjustment facilitator 16. The Internet access adjustment facilitator 22 is adapted to process requests from the user device 14 to the host for the control of Internet access. In this sense, the Internet access adjustment facilitator 22 is within a proxy server for connecting to the Internet. The requests are typically in the form of an electronic signal/message wherein a software application is installed on the mobile device 14 or personal computer (PC) for such a purpose. Other means of communicating with the adjustment facilitator 22 may be in the form of a simple text or Short Messaging Service (SMS), Unstructured Supplementary Service Data (USSD) messages or other similar messaging service.

The system 10 optionally comprises a subscriber database 18. The subscriber database 18 maintains details of the subscribers, such as the Mobile Subscriber Integrated Services Digital Network Number (MSISDN) of each subscriber mobile phone; and whether the subscriber is on any data service plans as well as the details of such plans including the expiry date of the prepaid plan (if applicable). The subscriber database 18 may further be in data communication with an accounting database 26 for the settlement and checking of available funds for the subscriber for user device 14. The accounting database 26 further maintains a history of transaction of each subscriber.

The whitelist 24 is in data communication with Internet access adjustment facilitator 22. The whitelist 24 maintains a list of web resources comprising URLs, and APIs and other web services as approved by telecommunications carrier 12. These approved URLs and APIs are considered “toll free”, i.e. available for free access by the user device 14 or free to be accessed by a user as far as charging/billing based on the data network of the telecommunications network 12 is concerned. Whitelist 24 is in data communication with Internet access adjustment facilitator 22.

The whitelist 24 and Internet access adjustment facilitator 22 are arranged to implement the “free access” or “toll free” access as described. In particular, such an arrangement may be supported by toggling between a billing infrastructure that implements a pay-per-specific time model and an independent billing module implementing the pay per action model, with the setting of the data bandwidth connection as zero tariff or switching off the billing infrastructure when a web resource within the whitelist 24 is accessed.

It is to be understood that the above embodiments have been provided only by way of exemplification of this invention, and that further modifications and improvements thereto, such as those detailed below, would be apparent to persons skilled in the relevant art.
The entire user interface of the phone, any app including the browser, any feature such as turning on the GPS function, any activity, including the triggering of such features as the accelerometer or simply swiping active the phone again, may be used as a storefront for notifying and cross-selling of apps. For example, a smartphone may be ‘swiped’ by a user to view any notification. Such swiping actions may be used as prospective triggers for the cross-sell of the various prepaid data plans.
Alternatively, access to a search engine (e.g. Google) with returned search results list may be used as a storefront for further recommendations of prepaid plans and related services. In such instances, the result of the searches will be displayed without any data charge; however any subsequent chosen result may trigger a prompt to purchase a recommended prepaid plan or be charged if the result has not been included in the ‘free’ zone (such as under a free trial period).
The embodiments are described with reference to a dedicated software application that communicates with a backend subscriber database to establish the various variables make recommendations. In the event where the dedicated software application (App) is not installed, the monitoring of the actions of the subscribers may be performed via other specific background software provided as part of the software suite when a user purchase a smartphone from the telecommunications carrier, and the recommendations made in the form of text/SMS messages initiated from the telecommunications carrier.
Further to the above, monitoring of actions of the subscribers may be performed at the service provider (e.g. telecommunications carrier) end or at the device phone (using ‘App’). In the former situation, monitoring may be implemented via one or more servers performing functions of a bandwidth adjustment facilitator or network traffic monitoring/shaping tool having access to the subscriber database. The servers may be hosted on site or via cloud architecture.
In another variant, monitoring at both the service provider (telecommunications carrier) and the device end may be performed concurrently.
While the described embodiments have provided examples of data service plans generally provided to user subscribers, it is to be appreciated that dynamically created data service plans suitable for a particular person may be available and defined at a more granular level, such Price Per Minute, Price Per View, Price depending on Time of Day and Location.

It should be further appreciated by the person skilled in the art that variations and combinations of features described above, not being alternatives or substitutes, may be combined to form yet further embodiments falling within the intended scope of the invention.

1. A system for provisioning data service plan to a user comprising:
a web resource traffic monitor arranged to monitor a user device access to at least one web resource and generate user access data; and
a data service planner arranged to receive the access data and recommend to the user a data service plans for subsequent assess to the at least one web resource;
wherein the data service plans include a pay-per-specific time data service plan or a pay per action data service plan.

2. The system according to claim 1, wherein the web resource traffic monitor is integrated with the user device.

3. The system according to claim 2, wherein the web resource traffic monitor is configured to run as a background application on the user device for the monitoring of access to the at least one web resource.

4. The system according to claim 1, wherein the web resource traffic monitor is configured to determine if the web resource is accessed by the user device for the first time.

5. The system according to claim 4, wherein if the web resource is accessed for the first time, the web resource is subsequently accessible without cost to the user for a pre-determined time.

6. The system according to claim 4, wherein if the web resource is accessed for the first time, the web resource is accessible without cost to the user for a subsequent predetermined number of access to the web resource.

7. The system according to claim 4, wherein if the web resource is not accessed by the user for the first time, the web resource traffic monitor is configured to determine a time difference between the previous access of the at least one web resource and the most recent access of the at least one web resource.

8. The system according to claim 7, wherein if the time difference is greater than a predetermined period, then subsequent access to the web resource is available without cost to the user for a pre-determined time.

9. The system according to claim 1, wherein the data service planner is in data communication with a subscriber database to check if the user is an existing subscriber of a data service plan.

10. The system according to claim 1, further comprising a whitelist in data communication with the web resource traffic monitor, the whitelist maintaining a list of web resources available for toll free access by the user device.

11. The system according to claim 1, wherein each subsequent action to access the web resource includes the actions retrieve, input or manipulate data.

12. The system according to claim 11, wherein each action to retrieve, input or manipulate data is charged or billed based on a flat fee for a defined set of subsequent actions.

13. A method for provisioning data service plan to a user comprising the steps of:
monitoring the user's access to a web resource; and
recommending a data service plans for subsequent access to the web resource based on the user's access to the web resource;
wherein the data service plan include a pay-per-specific time data service plan or a pay per action data service plan.

14. The method according to claim 13, wherein the step of monitoring the user's access to the web resource is performed on a user device.

15. The method according to claim 14, wherein the step of monitoring includes determining if the web resource is accessed by the user device for the first time.

16. The method according to claim 15, wherein if the web resource is accessed for the first time, the web resource is accessible without cost to the user for a pre-determined time.

17. The method according to claim 15, wherein if the web resource is accessed for the first time, the web resource is accessible without cost to the user for a subsequent predetermined number of access to the web resource.

18. The method according to claim 15, wherein if the web resource is not accessed by the user for the first time, the method includes a step of determining a time elapsed between the previous access of the at least one web resource and the most recent access of the at least one web resource.

19. The method according to claim 18, wherein if the time elapsed is greater than a predetermined period, then the web resource is accessible without cost by the user for a pre-determined time.

20. The method according to claim 13, wherein the step of recommending includes a step of checking if the user is an existing subscriber of a data service plan.
